(19) United States
(12) Patent Application Publication
(10) Pub. No.: US 2002/0184319 A1
(43) Pub. Date: Dec. 5, 2002

(54) Systems and methods for facilitating access to an information address

(76) Inventors: Barry E. Willner, Briarcliff Manor, NY (US); David P. Greene, Ossining, NY (US); Edith H. Stern, Yorktown Heights, NY (US); Philip Shi-lung Yu, Chappaqua, NY (US)

Correspondence Address: BUCKLEY, MASCHOFF, TALWALKAR, & ALLISON, 5 ELM STREET, NEW CANAAN, CT, 06840, US

(21) Appl. No.: 09/871,364

(22) Filed: May 31, 2001

(51) Int. Cl. G06F 15/16; G06F 15/173

(52) U.S. Cl. 709/206; 709/238

(57) ABSTRACT

Systems and methods are provided to facilitate access to an information address. According to one embodiment, it is determined that an information address is related to an electronic message. For example, a URL address may be received in an e-mail message. The information address is then associated with the electronic message and/or a message address. According to another embodiment, an information address is determined along with metadata associated with the information address (e.g., by accessing a Web site associated with a URL address). It is then determined at a user device whether or not the information address will be stored based on the metadata.

### FIELD

The present invention relates to information addresses. In particular, the present invention relates to systems and methods for facilitating access to an information address.

### BACKGROUND

Many people access information content using information addresses. For example, a person may access a Web page via the Internet by entering a Uniform Resource Locator (URL) address into a browser program running on his or her Personal Computer (PC). However, a person may find it difficult to remember such a URL address (e.g., “http://dir.yahoo.com/Recreation/Sports”) and/or inconvenient to enter the URL address each time each time he or she wants to access a Web page.

It is known that a person can decide to store a URL address in a list of commonly used addresses maintained at his or her computer. For example, a person may view a Web page and decide to add the associated URL address to a list of “bookmarks” in the NAVIGATOR® browser program (available from NETSCAPE®) or a list of “favorites” in the INTERNET EXPLORER® browser program (available from MICROSOFT®). The person can then re-visit the Web page by simply selecting the appropriate address from the stored list of addresses (i.e., he or she does not need to remember and re-enter the URL address). Typically, the list of URL addresses is organized using a directory structure (e.g., some addresses may be listed in a “sports” folder while others are listed in a “work” folder).

There are several disadvantages, however, with having a person decide whether or not a URL address will be stored such a list. For example, this approach requires that a person evaluate each Web page he or she accesses to determine if the URL address should be stored. Naturally, a person will occasionally forget to indicate that an interesting URL address should be stored and/or mistakenly indicate that a URL address of little interest should be stored in the list.

Moreover, a person may be unable to accurately determine if a particular URL address should be stored. Consider, for example, a person who accesses a particular Web page for the first time. The Web page normally contains a lot of information about the person's favorite hobby, but on this day the Web page happens to have very little information about that hobby. As a result, the person will probably decide to not store the URL address—even thought the address would normally be of interest.

In addition to accessing Web pages, many people exchange information via electronic messages. For example, many people send and receive electronic mail messages (i.e., “e-mail” messages) via the Internet. Often, these messages include a reference to a URL address that might be of interest to the recipient (e.g., “Sam, you should visit ‘www.store.com’ because the new bicycle you want to buy is on sale this week—Bob”). When a person receives a large number of electronic messages, however, it may be difficult to find a particular URL address that was included in a message (e.g., Sam may need to review fifty messages from Sam to find the reference to “www.store.com”).

It is known that e-mail messages, which generally include a short text message, can also include file “attachments” (e.g., a picture or a word processing document). When a person views a list of stored e-mail messages, an icon can be displayed next to those messages that include a file attachment (e.g., a small paper clip may be displayed next to those messages). This feature lets a person more readily find a file attachment but does not help a person who wants to a find a URL address. Similarly, a person who views a list off stored URL addresses has no way of determining which addresses were originally received via an e-mail message.

### SUMMARY

To alleviate problems inherent in the prior art, the present invention introduces systems and methods for facilitating access to an information address.

In particular, one embodiment facilitates access with respect to an information address and an electronic message, wherein the information address is associated with information content and the electronic message is associated with a message address. According to this embodiment, it is determined that the information address is related to the electronic message. The information address is then associated with the electronic message and/or the message address.

Another embodiment is directed to a computer-implemented method of facilitating access to a Web page. In this case, an e-mail message is received including a URL address associated with the Web page. Metadata associated with the e-mail message and/or the Web page is then determined. The URL address is stored in a directory structure, in accordance with the metadata, along with an indication associated with the e-mail message.

Still another embodiment is directed to facilitating storage of an information address associated with information content stored at an information server. According to this embodiment, the information address is determined along with metadata associated with the information content. It is then determined at a user device (remote from the information server) whether or not the information address will be stored based on the metadata.

Another embodiment is directed to a computer-implemented method of facilitating storage of a URL address associated with a Web page. In this case, the URL address is received at a user device, and metadata associated with the URL address is determined. The user device also determines whether or not the URL address will be stored based on the metadata, and the URL address is stored in a directory structure in accordance with the metadata.

One embodiment of the present invention is directed to facilitating access with respect to an information address and an electronic message, wherein the information address is associated with information content and the electronic message is associated with a message address. This embodiment comprises: means for determining that the information address is related to the electronic message; and means for associating the information address with at least one of: (i) the electronic message, and (ii) the message address.

Another embodiment comprises: means for receiving an e-mail message including a URL address associated with a Web page; means for determining metadata associated with at least one of: (i) the e-mail message, and (ii) the Web page; means for storing the URL address in a directory structure in accordance with the metadata; and means for storing with the URL address an indication associated with the e-mail message.

Another embodiment comprises: means for determining an information address associated with information content stored at an information server; means for determining metadata associated with the information content; and means for determining at a user device remote from the information server whether the information address will be stored based on the metadata.

Still another embodiment is directed to a computer-implemented method of facilitating storage of a URL address associated with a Web page. This embodiment may comprise: means for receiving at a user device the URL address; means for determining at the user device metadata associated with the URL address; means for determining at the user device whether the URL address will be stored based on the metadata; and means for storing the URL in a directory structure in accordance with the metadata.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is an information flow diagram according to an embodiment of the present invention.

FIG. 2 is a block diagram overview of an information system according to an embodiment of the present invention.

FIG. 3 is a flow chart of a method according to one embodiment of the present invention.

FIG. 4 illustrates user displays according to one embodiment of the present invention shown in FIG. 3.

FIG. 5 is a flow chart of a method according to another embodiment of the present invention.

FIG. 6 illustrates user displays according to one embodiment of the present invention shown in FIG. 5.

FIG. 7 is a block diagram of a user device according to an embodiment of the present invention.

FIG. 8 is a tabular representation of a portion of an electronic message database according to an embodiment of the present invention.

FIG. 9 is a tabular representation of a portion of an information address database according to an embodiment of the present invention.

FIG. 10 is a tabular representation of a portion of a user preference database according to an embodiment of the present invention.

FIG. 11 is a tabular representation of a portion of a pre-determined rule database according to an embodiment of the present invention.

FIG. 12 is a flow chart of a computer-implemented method of facilitating access to a Web page according to an embodiment of the present invention.

FIG. 13 is a flow chart of a computer-implemented method of facilitating storage of a URL address according to another embodiment of the present invention.

### DETAILED DESCRIPTION

Embodiments of the present invention are directed to systems and methods for facilitating access to an “information address.” As used herein, the phrase “information address” refers to any information that can be used to access information. For example, an information address might be a URL address that can be used to access a Web page via the Internet. Other examples of an information address include a Uniform Resource Identifier (URI) and a Uniform Resource Name (URN). An information address might also be an Internet Protocol (IP) address that can be used to access information or a File Transfer Protocol (FTP) address that can be used to download programs or other files to a computer. According to one embodiment, an information address may comprise a telephone number (e.g., a telephone number that can be used to access a computer network).

The information address is associated with “information content.” As used herein, the phrase “information content” refers to any information that can be accessed via an information address. For example, information content may be a Hyper-Text Markup Language (HTML) Web page accessed via a URL address or an information file (e.g., a text, audio, or image file) accessed via an FTP address.

Some embodiments of the present invention are also associated with “electronic messages.” As used herein, the phrase “electronic message” refers to information that is electronically transmitted from one user to another. For example, an electronic message may be an e-mail message. An electronic message may also be an Instant Message (IM), such as an AMERICA ON-LINE® IM or MICROSOFT NETWORK® IM.

An electronic message may be associated with a “message address.” As used herein, the phrase “message address” refers to information that describes an origin or a destination of an electronic message. For example, a message address may comprise Simple Mail Transfer Protocol (SMTP) information, Post Office Protocol 3 (POP3) information, or IM information.

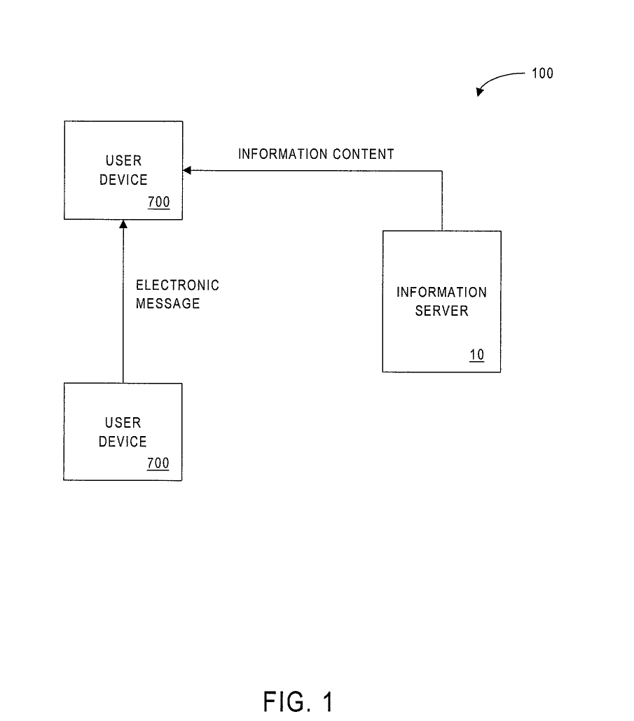

Turning now in detail to the drawings, FIG. 1 is an information flow diagram 100 according to one embodiment of the present invention. As shown in FIG. 1, a user device 700 can receive information content from an information server 10. For example, a user's PC may access information associated with a Web page from an information provider. The user device 700 may access such information content via an associated information address (e.g., a URL address such as “http://www.uspto.gov/”).

As is also shown in FIG. 1, an electronic message may be sent from one user device 700 (i.e., an origination device) to another user device 700 (i.e., a destination device). For example, a first user's PC may transmit an e-mail message to a second user's PC or wireless telephone. In this case, the e-mail message will have an origination message address (e.g., such as “bob@aol.com” associated with the first user's PC) and a destination message address (e.g., associated with the second user's PC or wireless telephone).

The electronic message may include, for example, text, audio, or image information and/or file attachments. The electronic message may also include an information address associated with information content. For example, an e-mail message may state “Jane, have you seen the www.yankeefans.com Web site? I think you'll enjoy it!” Jane can then select the URL address (e.g., by clicking on the underlined text using a mouse coupled to her PC) to view the information content associated with the Web page.

Information System Overview

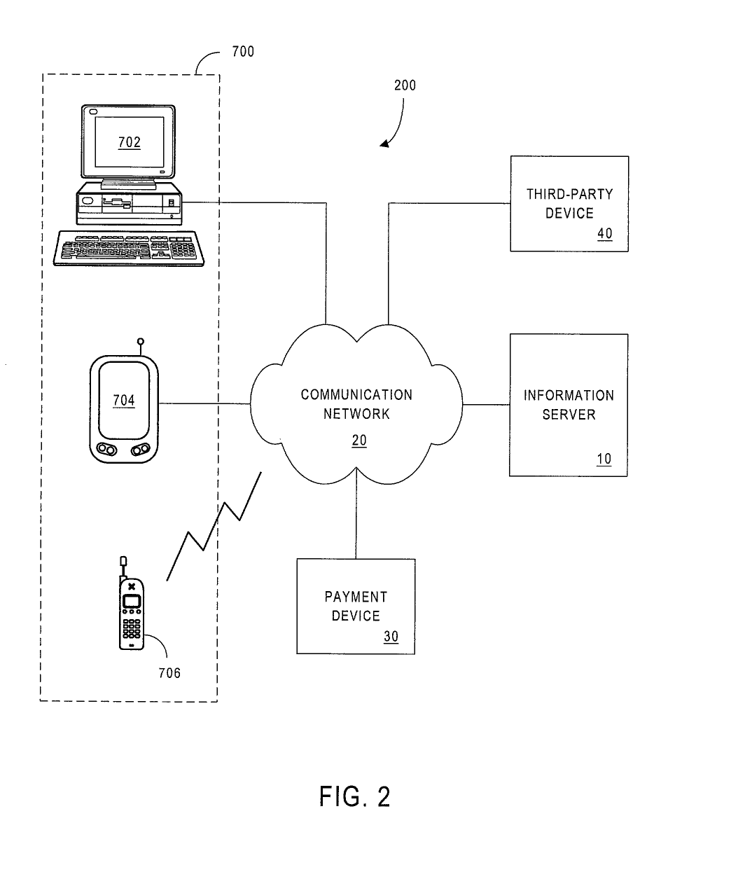

FIG. 2 is a block diagram of an information system 200 according to one embodiment of the present invention. The information system 200 includes an information sever 10 in communication with a number of user devices 700. As used herein, devices (such as the user devices 700 and the information server 10) may communicate, for example, via a communication network 20, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network (e.g., in accordance with an 802.11 standard), and/or an Internet Protocol (IP) network such as the Internet, an intranet, or an extranet.

Although a single information server 10 is shown in FIG. 2, any number of information servers 10 may be included in the information system 200. Similarly, any number of user devices 700, or any other device described herein, may be included in the information system 200 according to embodiments of the present invention.

The information server 10 and the user devices 700 may be any devices capable of performing the various functions described herein. The information server 10 may be, for example, a Web server or an e-mail server. The user devices 700 may be, for example: a PC 702, a portable computing device 704 such as a Personal Digital Assistant (PDA), a wired or wireless telephone 706, or any other appropriate storage and/or communication device.

The information system 200 may also include a payment device 30 (e.g., a credit card authorization device) that can be used to arrange for a user to provide or receive payment. For example, a user may provide or receive payment via a payment identifier such as a credit card, debit card, or bank account number or digital payment protocol information.

As shown in FIG. 2, the information system 200 may also include a third-party device 40. The third-party device 40 may be associated with, for example, a service that rates or otherwise provides information about Web pages. According to another embodiment, the third-party is a group of other users who provide information about Web pages.

Embodiment Associating an Information Address with an Electronic Message

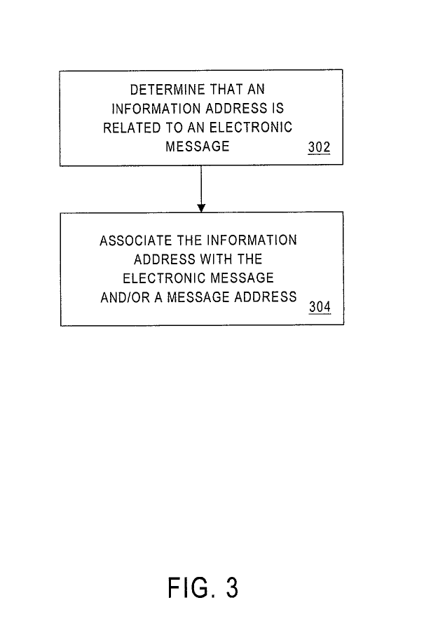

FIG. 3 is a flow chart of a method that may be performed by a user device 700 to associate an information address with an electronic message according to one embodiment of the present invention. The information address may comprise, for example, a URL address associated with information content (e.g., a Web page). The electronic message may comprise, for example, an e-mail message associated with a message address (e.g., an origination e-mail message address). The flow charts described herein do not imply a fixed order to the steps, and embodiments of the present invention can be practiced in any order that is practicable.

At 302, it is determined that the information address is related to the electronic message. For example, a user device 700 may receive an e-mail message and determine that the message includes a URL address, such as by locating text beginning with “www.” or other information in the message (e.g., underlined text or “tags” associated with a portion of the message). This step may be performed, for example, each time an e-mail message is received at a user device 700. According to another embodiment, this step is instead performed on a batch of e-mail messages that have been received.

At 304, the information address is associated with the electronic message and/or the message address. For example, the user device 700 may store an indication of the information address (e.g., the information address itself or information content associated with the information address) in association with an indication of the electronic message (e.g., the electronic message itself or a message address from which the message originated).

Consider the following e-mail message received at a user device 700 from bob@aol.com: “Jane, have you seen the www.yankeefans.com Web site? I think you'll enjoy it!” In this case, the user device 700 may determine that the e-mail message includes a URL address (i.e., “www.yankeefans.com”). The user device 700 then stores the URL address in a list of frequently used addresses (e.g., a bookmark or favorites list).

According to one embodiment, the user device 700 also stores “bob@aol.com” along with the URL address. In this way, when Jane views the list of URL addresses she can determine which addresses were received from bob@aol.com. For example, the associated e-mail address may be displayed to a user next to the URL address. According to another embodiment, the e-mail address is not displayed, but a user can still access the association via a user device 700. For example, Jane might request a list of all URL addresses that are associated with bob@aol.com (e.g., that were received via an e-mail message from bob@aol.com).

According to still another embodiment, a URL address can be associated with a destination message address. For example, Jane may request a list of all URL addresses that she has sent to bob@aol.com via electronic messages.

According to yet another embodiment, Jane may request a list of every e-mail messages that contains a URL address (i.e., regardless of the origination address). Similarly, Jane may request a list of every e-mail message she has received from bob@aol.com that includes at least one URL address.

In addition to associating the information address with the electronic message (or message address), the user device 700 can also determine “metadata” associated with the electronic message and/or the information content.

As used herein, the term “metadata” refers to any information that defines and/or describes data. One example of metadata is Extensible Markup Language (XML) information, which can be used by information providers to create common information formats. For example, automobile manufacturers might agree on a standard format to describe information about automobile models (e.g., miles per gallon and price) and then define the format using XML information. Note that both XML and HTML documents can contain elements that describe information content—and thus both of these languages may be used to determine metadata. XML is “extensible” because the language is unlimited and self-defining. For example, one extension of XML is the XML Bookmark Exchange Language (XBEL), which can be used to exchange hierarchical bookmark data.

A user device 700 may, for example, examine an electronic message or information content to locate HTML, XML, and/or XBEL “metadata” provided via an information server 10. The user device 700 can then store an indication of the information address (e.g., the URL address) and/or an indication of the electronic message (e.g., the e-mail address) in accordance with the metadata. For example, the information may be stored in a directory structure (e.g., in a “personal” folder or a “work” folder) in accordance with the metadata.

Other types of metadata can also be determined by the user device 700 in accordance with embodiments of the present invention. For example, an e-mail message or Web page may be evaluated to determine a number of keywords that appear in the message. Similarly, information may be evaluated to determine a category associated with the information (e.g., whether information is associated with “sports news” or “financial news”).

According to another embodiment, the metadata comprises third-party information. For example, a third-party device 40 may transmit metadata (e.g., a rating of a Web page) to the user device 700 in exchange for payment provided via the payment device 30. The metadata may also comprise information locally determined by the user device 700, such as quantity of information (e.g., the size of a Web page) or date information (e.g., the last time the Web page was updated). The metadata may also be associated with, for example, an information source (e.g., a information content provider). Note that a plurality of metadata types can be combined by the user device 700 (e.g., using a weighted scoring method).

As described herein, an information address may be associated with an electronic message. According to another embodiment, a plurality of information addresses are associated with a single indication of an electronic message. For example, a single e-mail message may contain references to several different URL addresses. As another example, several messages, each containing a single URL address, may have been received from the same e-mail address.

Similarly, a plurality of electronic messages may be associated with a single indication of an information address. For example, a number of e-mail messages from different e-mail addresses may refer to a single URL address.

In addition to associating an information address with an electronic message, the user device 700 can also determine whether or not information will be stored. For example, the user device 700 may determine metadata associated with an e-mail message (or a Web page referenced in the e-mail message) to determine whether or not a URL address will be added to a list of addresses. Similarly, the user device 700 may determine how long information will be stored (e.g., a bookmark may be created for thirty days based on metadata) and/or a device at which information will be stored (e.g., at a PC or a PDA). The user device 700 may also determine whether information will be deleted and/or whether information will be replaced. For example, an e-mail message may indicate that a referenced URL address is no longer of interest. The user device 700 may also determine whether another electronic message will be generated. For example, when a particularly interesting URL address is received (as determined based on metadata associated with the Web page), the original e-mail message may be automatically forwarded to another e-mail address.

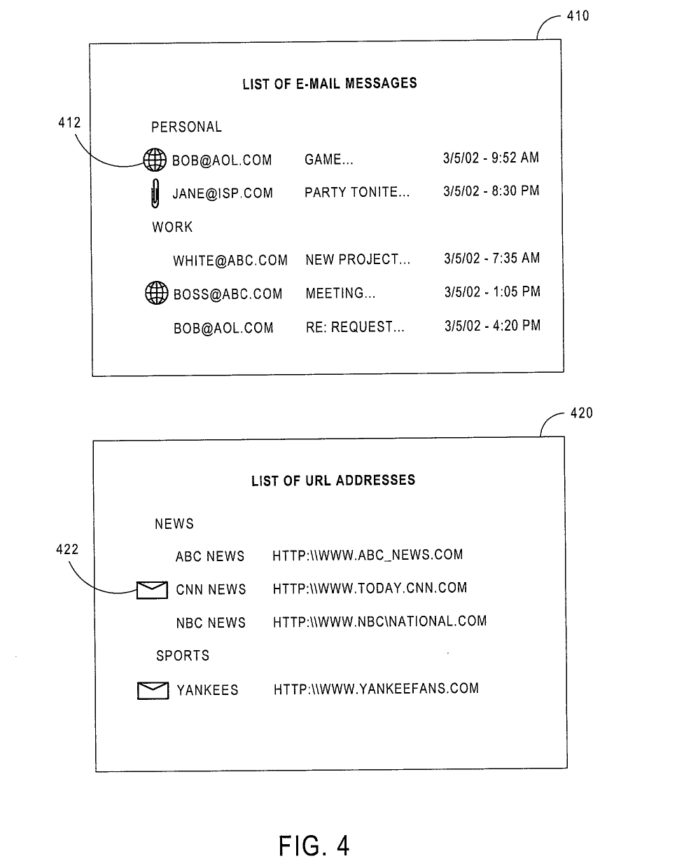

FIG. 4 illustrates user displays 410, 420 that may be presented via a user device 700 according to one embodiment of the invention shown in FIG. 3. The first user display 410 illustrates a list of e-mail messages that have been received at a user device 700. As can be seen, the e-mail messages are stored in a directory structure (i.e., some are listed as “personal” messages while others are listed as “work” messages). Note that the e-mail message received from “jane@isp.com” is associated with a file attachment (i.e., as indicated by the paperclip icon displayed next to the e-mail message).

According to this embodiment of the present invention, an indication of an information address is provided in association with an indication of an electronic message. In particular, an address icon 412 is displayed proximate to some of the e-mail messages in the list (i.e., a globe is displayed near e-mail messages from “bob@aol.com” and “boss@abc.com”). In this way, a user can view of the list of e-mail messages and quickly determine which of those messages include a URL address. According to one embodiment, the e-mail message itself is stored in the directory structure based on metadata associated with the referenced Web page.

According to one embodiment, the user can select the address icon 412 to view the URL address. According to another embodiment, selection of an address icon 412 results in the display of the Web page associated with the URL address (e.g., a browser program may be automatically activated).

The second user display 420 illustrates a list of URL addresses that are stored at the user device 700. As can be seen, the URL addresses are stored in a directory structure (i.e., some are listed as “news” addresses while others are listed as “sports” addresses). Note that this directory structure may or may not be related to the e-mail message directory structure (e.g., the directory structure shown in the first user display 410).

According to this embodiment, an indication of an electronic message is provided in association with an indication of an information address. In particular, a message icon 422 is displayed proximate to some of the URL addresses in the list (i.e., an envelope is displayed near the “CNN News” and “Yankees” URL addresses). In this way, a user can view of the list of URL addresses and quickly determine which of those addresses are associated with an e-mail message (e.g., were originally received in an e-mail message). According to one embodiment, the indication of the URL address itself is stored in the directory structure based on metadata associated with the e-mail message. According to other embodiments, the message icon 422 can also indicate: (i) that the user has sent that URL address to another user in an e-mail message or (ii) the user device 700 had already stored the URL address and that URL address was then received from another user via an e-mail message.

According to one embodiment, the user can select the message icon 422 to view the associated e-mail message address or the e-mail message itself (e.g., an e-mail program may be automatically activated).

Embodiment Facilitating Storage of an Information Address

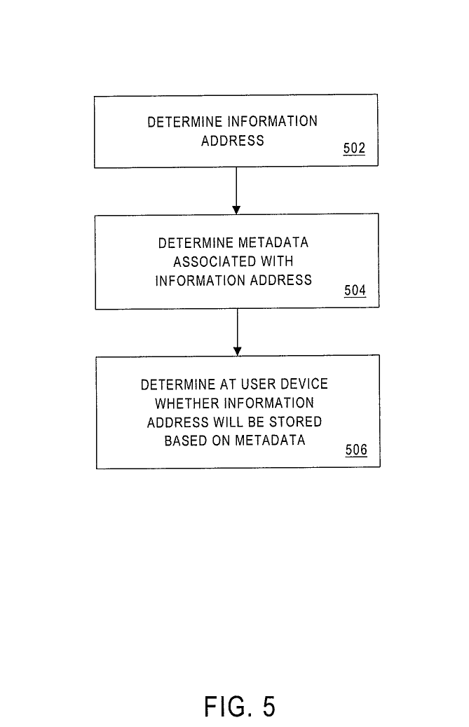

FIG. 5 is a flow chart of a method that may be performed by a user device 700 to facilitate storage of an information address according to one embodiment of the present invention. The information address may comprise, for example, a URL address associated with information content stored at an information server 10 (e.g., a Web page).

At 502, an information address is determined. For example, a user device 700 may determine the information address when a user enters a URL address (e.g., via a computer keyboard) or when a user selects an HTML link associated with a URL address (e.g., via a computer mouse). The user device 700 may also, for example, extract the information address from an electronic message (e.g., by extracting a URL address contained in an e-mail message or an IM). According to another embodiment, the user device 700 extracts the information address from information content. For example, the user device 700 may extract a number of URL addresses that are referenced on a Web page. According to still another embodiment, the user device 700 retrieves a pre-stored indication of the information address. For example, the user device 700 may access a pre-stored list of information addresses (e.g., a bookmark or favorites list).

At 504, metadata associated with the information content is determined by the user device 700. The metadata may comprise, for example, any of the information described with respect to FIG. 3. For example, the metadata may comprise XML information, HTML information, and/or XBEL information provided via an information server 10.

At 506, the user device 700 determines whether or not the information address will be stored based on the metadata. For example, the user device 700 may evaluate XML information associated with a Web page to determine if an associated URL address will be automatically stored in the user's bookmark or favorites list.

In addition to the metadata, the user device may determine whether or not an information address will be stored based on a pre-determined rule and/or a user preference. For example, a user might indicate that every URL address associated with a Web page that contains his or her name should be automatically stored.

If the user device 700 determines that the information address will be stored, an indication of the information address can be stored locally at the user device 700. For example, a URL address may be stored at the user device 700 in a directory structure (e.g., in a “news” folder or a “sports” folder) in accordance with the metadata. In addition to the information address, the user device 700 may also store an indication of the metadata that caused the URL address to be stored and/or filed in a particular directory. In this way, the user device 700 may be able to, for example, intelligently adjust a bookmark or favorites list when a user preference, a pre-determined rule, and/or a directory structure is adjusted (e.g., by the user).

The user device 700 may also determine how long information will be stored (e.g., a bookmark may be created for thirty days based on metadata) and/or a device at which information will be stored (e.g., at a PC or a PDA). The user device 700 may also determine whether information will be deleted and/or whether information will be replaced. For example, a URL address may be deleted if an associated Web page no longer contains a pre-determined number of keywords. Similarly, a first URL address (associated with a first Web page) may be replaced by a second URL address (associated with a second Web page) if it is determined that the second Web page contains more keywords than the first Web page.

The user device 700 may also determine whether an electronic message will be automatically transmitted or generated (e.g., a proposed electronic message can be generated by the user device 700 and the user may be asked if he or she would like to send, modify, or cancel the proposed message). For example, when a particularly interesting Web page is being accessed by a user (as determined based on associated metadata), an e-mail message may be automatically transmitted to a pre-determined e-mail address.

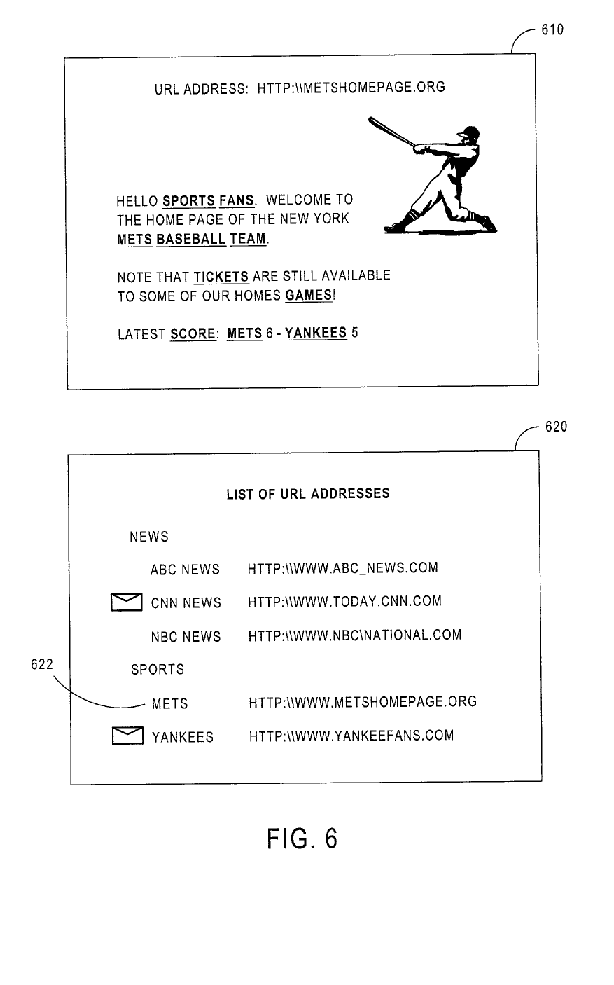

FIG. 6 illustrates two user displays 610, 620 that may be presented via a user device 700 according to one embodiment of the invention shown in FIG. 5. The first user display 610 shows a Web page (i.e., information content) associated with a URL address (i.e., an information address) being accessed by a user. The user device 700 determines that ten keywords associated with sports are included in the Web page (i.e., the ten underlined words shown in the first user display 610).

Prior to accessing this Web page, the user's list of URL addresses was as shown in the second user display 420 in FIG. 4 (i.e., the “sports” directory included only the “Yankees” URL address). Based on the ten keywords that were found on the Web page, the user's list of URL addresses is automatically updated by the user device 700 as shown in the second user display 620 in FIG. 6 (i.e., the “Mets” URL address 622 has been added to the “sports” directory). In this way, the user's list of URL addresses may be intelligently updated without requiring the user to make a decision each time he or she accesses a Web page (e.g., “do I want to store this particular URL address?”)

User Device

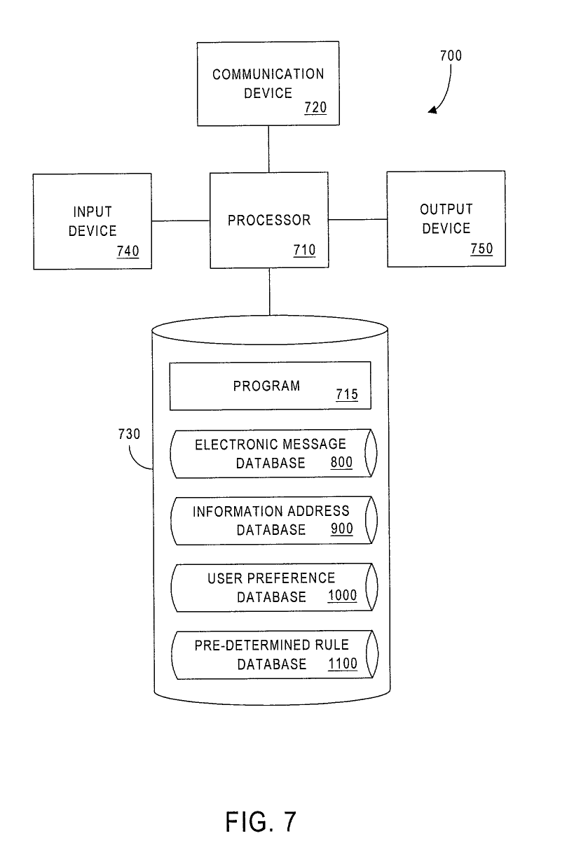

FIG. 7 illustrates a user device 700 that is descriptive of the device shown, for example, in FIGS. 1 and 2 according to an embodiment of the present invention. The user device 700 comprises a processor 710, such as one or more INTEL® Pentium® processors, coupled to a communication device 720 configured to communicate via a communication network 20 (not shown in FIG. 7). The communication device 720 may be used to communicate, for example, with one or more information servers 10, payment devices 30, and/or third-part devices 40. The communication device 720 may also be used to communicate with other user devices.

The processor 710 is also in communication with an input device 740. The input device 740 may comprise, for example, a keyboard, a mouse or other pointing device, a microphone, a knob or a switch (including an electronic representation of a knob or a switch), an infrared port, a docking station, and/or a touch screen. Such an input device 740 may be used, for example, by a user to enter an electronic message, an information address, and/or a user preference.

The processor 710 is also in communication with an output device 750. The output device 750 may comprise, for example, a display (e.g., a computer monitor), a speaker, and/or a printer. The output device 450 may be used, for example, to indicate to a user a an electronic message, a list of electronic messages, information content, and/or a list of information addresses.

The processor 710 is also in communication with a storage device 730. The storage device 730 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 730 stores a program 715 for controlling the processor 710. The processor 710 performs instructions of the program 715, and thereby operates in accordance with the present invention. For example, the processor 710 may determine that an information address is related to and electronic message and associate the information address with the electronic message and/or the message address.

According to another embodiment, the processor 710 receives an e-mail message including a URL address associated with a Web page. The processor 710 determines metadata associated with the e-mail message and/or the Web page, and stores the URL address in a directory structure in accordance with the metadata. The processor 710 may also store with the URL address an indication associated with the e-mail message.

According to still another embodiment, the processor 710 determines an information address (e.g., a URL address) along with metadata associated with information content (e.g., a Web page associated with the information address). The processor 710 then determines whether or not the information address will be stored based on the metadata.

According to yet another embodiment, the processor 710 receives a URL address and determines metadata associated with the URL address (e.g., by determining metadata associated with a Web page). The processor 710 then (i) determines whether or not the URL address will be stored based on the metadata and (ii) stores the URL address in a directory structure in accordance with the metadata.

As used herein, information may be “received” by or “transmitted” to, for example: (i) the user device 700 from an information server 10 or a third-party device 40; or (ii) a software application or module within the user device 700 from another software application, module, or any other source.

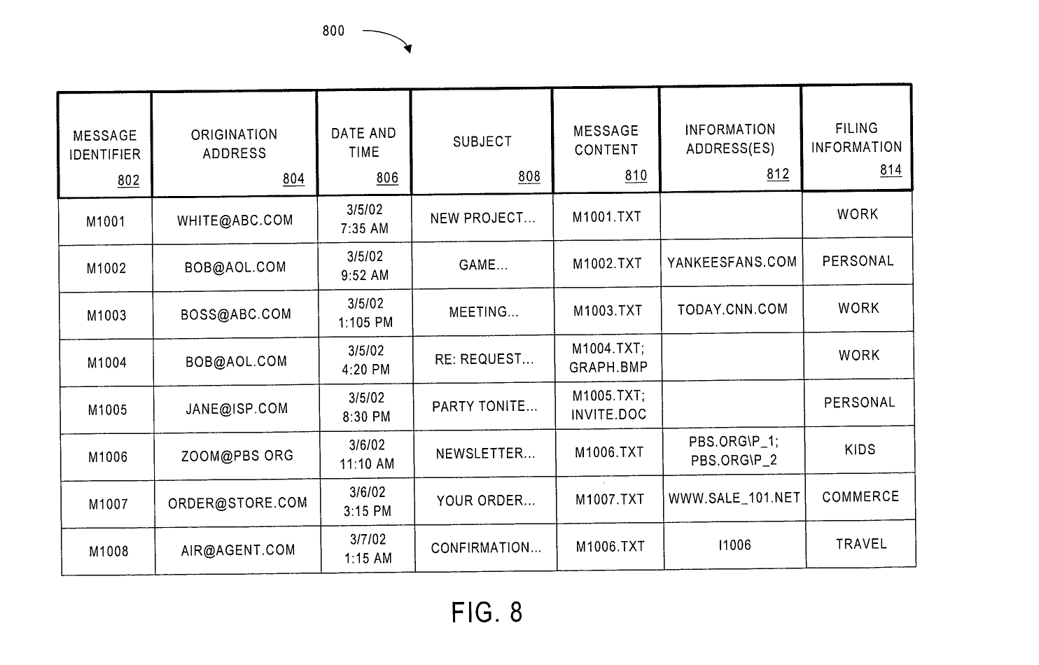

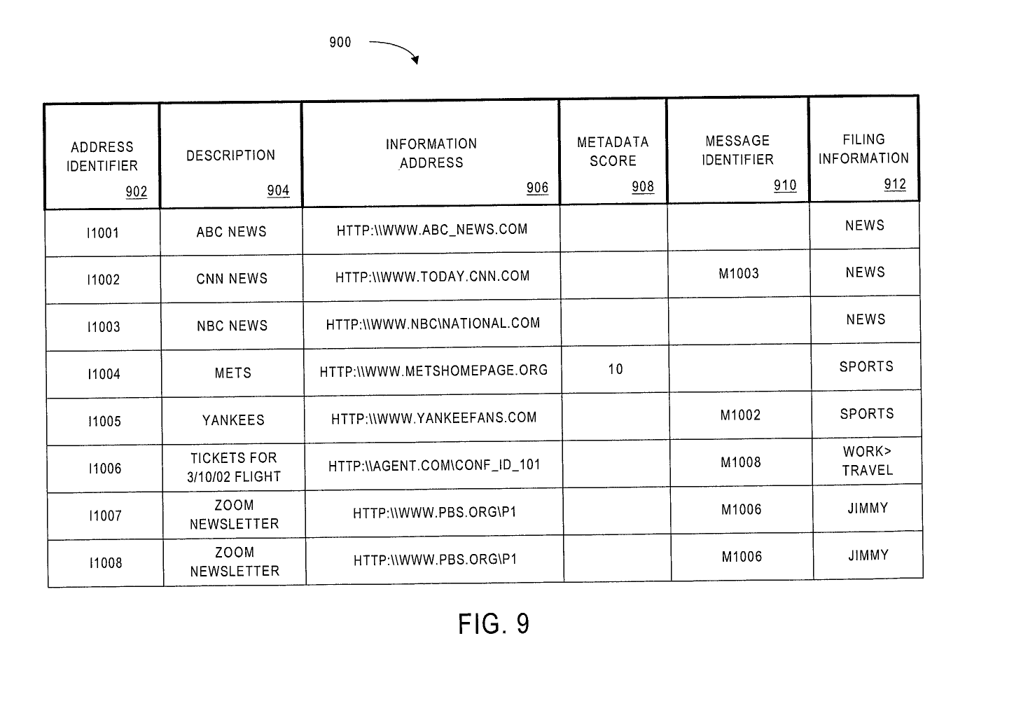

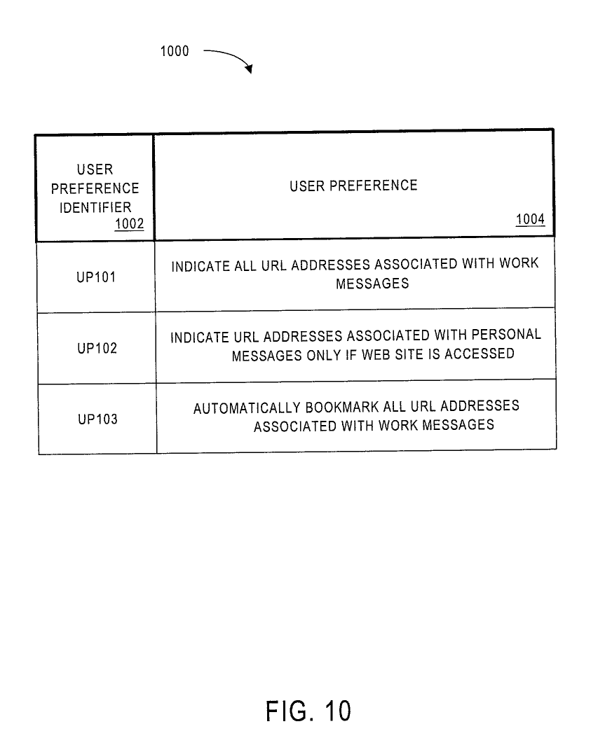

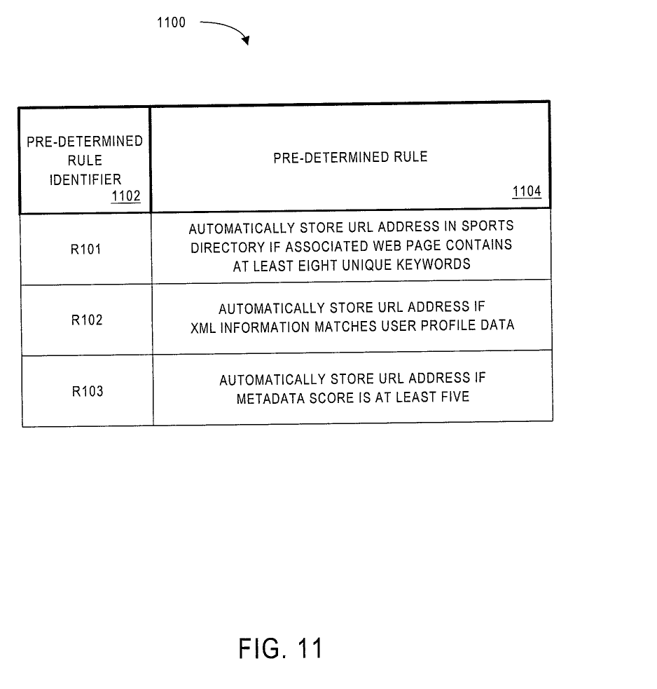

As shown in FIG. 7, the storage device 730 also stores: an electronic message database 800 (described with respect to FIG. 8); an information address database 900 (described with respect to FIG. 9); a user preference database 1000 (described with respect to FIG. 10); and a pre-determined rule database 1100 (described with respect to FIG. 11). Examples of databases that may be used in connection with the information system 200 will now be described in detail with respect to FIGS. 8 through 11. The illustrations and accompanying descriptions of the databases presented herein are exemplary, and any number of other database arrangements could be employed besides those suggested by the figures.

Electronic Message Database

Referring to FIG. 8, a table represents the electronic message database 800 that may be stored at the user device 700 according to an embodiment of the present invention. The table includes entries identifying electronic messages (e.g., e-mail messages) that have been received by the user device 700. The table also defines fields 802, 804, 806, 808, 810, 812, 814 for each of the entries. The fields specify: a message identifier 802, an origination address 804, a date and time 806, a subject 808, message content 810, one or more information addresses 812, and filing information 814. The information in the electronic message database 800 may be created and updated, for example, based on information received from other user devices (e.g., via an e-mail server and/or the communication network 20).

The message identifier 802 may be, for example, an alphanumeric code associated with an electronic message that has been received by the user device 700. The origination address 804 is the message address (e.g., the e-mail address) from which the electronic message was received. The date and time 806 indicates when the message was sent and/or received, and the subject 808 describes the electronic message. The origination address 804, the date and time 806, and/or the subject 808 may be, for example, displayed to a user in a list of his or her electronic messages.

The message content 810 may indicate, for example, text, audio, and/or image information contained in the electronic message. The information address 812 indicates any information addresses (e.g., URL addresses) that are associated with the electronic message (e.g., that are referred to in the electronic message). For example, the electronic message having a message identifier 802 of “M1002” includes a reference to “yankeefans.com” as illustrated by the second entry in the table. According to one embodiment, an indication based on the information address 812 is displayed to a user (e.g., via an address icon 412 in a list of electronic messages).

The filing information 814 represents information associated with the storage of the electronic message in a directory structure. For example, the filing information 814 may indicate that the electronic message should be stored in a “work” folder or in a “personal” folder. According to one embodiment, the filing information 814 is based at least in part on the information addresses 812 (and/or the information content associated with those addresses).

Information Address Database

Referring to FIG. 9, a table represents the information address database 900 that may be stored at the user device 700 according to an embodiment of the present invention. The table includes entries identifying information addresses that are stored at the user device 700, such as a bookmark or favorites list. The table also defines fields 902, 904, 906, 908, 910, 912 for each of the entries. The fields specify: an address identifier 902, a description 904, an information address 906, a metadata score 908, a message identifier 910, and filing information 912. The information in the information address database 900 may be created and updated, for example, based on information content accessed by a user and/or electronic messages received by the user device 700.

The address identifier 902 may be, for example, an alphanumeric code associated with an information address. The description 904 describes the information address and/or associated information content. The description 904 may be based on, for example, an HTML “title” element or tag associated with a Web page. The information address 906 represents the actual information address that can be used to access information content (e.g., a URL address that is used to access a Web page). Note that the information address 906 may be based on, or associated with, the information addresses 812 stored in the electronic message database 800.

The metadata score 908 represents a value associated with information content. The metadata score 908 may indicate, for example, a number of keywords that are included in a Web page (e.g., the “Mets” Web page contains ten sports related keywords as illustrated by the fourth entry in the table).

The message identifier 910 indicates any electronic messages that include a reference to the information address. For example, the “CNN News” URL address was referenced in an electronic message having a message identifier 910 of “M1003.” In this way, an indication that an information address was originally received via an electronic message can be displayed to a user (e.g., via a message icon 422 in a list of his or her favorite URL addresses). Note that the message identifier 910 may be based on, or associated with, the message identifier 802 stored in the electronic message database 800.

The filing information 912 represents information associated with the storage of the information address in a directory structure. For example, the filing information 912 may indicate that the information address should be stored in a “news” folder or in a “sports” folder. According to one embodiment, the filing information 912 is based at least in part on information associated with an electronic message. Note that the filing information 912 can be based on, or associated with, the filing information 814 stored in the electronic message database 800.

User Preference Database

Referring to FIG. 10, a table represents the user preference database 1000 that may be stored at the user device 700 according to an embodiment of the present invention. The table includes entries identifying when and/or how an information address should be stored, indicated, and/or associated with an electronic message. The table also defines fields 1002, 1004 for each of the entries. The fields specify a user preference identifier 1002 and a user preference 1004. The information in the user preference database 1000 may be created and updated, for example, based on information received from a user (e.g., as entered or selected by a user via the input device 740).

The user preference identifier 1002 may be, for example, an alphanumeric code associated with a user's preference, and the user preference 1004 defines when and/or how the information addresses should be stored, indicated, and/or associated with electronic messages. For example, the user preference 1004 may state that all URL addresses associated with “work” e-mail messages should be indicated to a user (e.g., via an address icon 412 in a list of e-mail messages).

Pre-Determined Rule Database

Referring to FIG. 11, a table represents the pre-determined rule database 1100 that may be stored at the user device 700 according to an embodiment of the present invention. The table includes entries identifying when and/or how an information address should be automatically stored. The table also defines fields 1102, 1104 for each of the entries. The fields specify a pre-determined rule identifier 1102 and a predetermined rule 1104. The information in the pre-determined rule database 1100 may be created and updated, for example, based on information received from a user (e.g., as entered or selected by a user via the input device 740).

The pre-determined rule identifier 1102 may be, for example, an alphanumeric code associated with a rule, and the pre-determined rule 1104 defines when and/or how an information address should be automatically stored at the user device 700. For example, the pre-determined rule 1104 may state that a URL address should be automatically stored when XML information associated with a Web page matches user profile data (e.g., demographic and survey data associated with the user).

Information System Methods

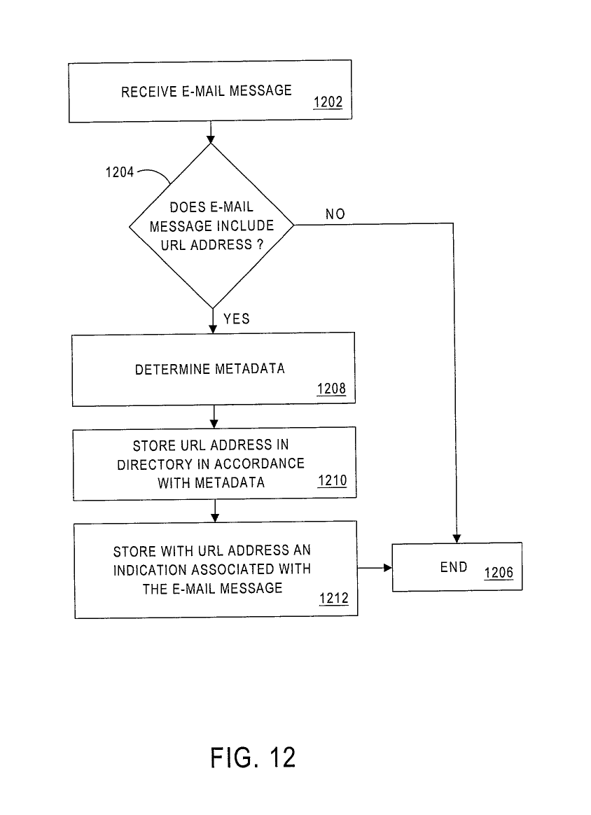

FIG. 12 is a flow chart of a computer-implemented method of facilitating access to a Web page according to an embodiment of the present invention. The method may be performed, for example, by a user device 700. At 1202, an e-mail message is received. For example, the user device 700 may receive an e-mail message from another user device (e.g., via an e-mail server and/or the communication network 20). The user device 700 may then store the e-mail message in the electronic message database 800.

At 1204, it is determined if the received e-mail message includes a URL address associated with a Web page. For example, the user device 700 may examine the e-mail message (e.g., the message content 810) to determine if the message includes a reference to a URL address. If the e-mail message does not include a URL address at 1204, the process ends at 1206.

If the e-mail message does include a URL address at 1204, the URL address may be stored as an information address 812 in the electronic message database 800. The user device 700 then determines metadata associated with the e-mail message and/or the Web page associated with the URL address at 1208. For example, the user device 700 may detect keywords in the message content 810 or receive XML information associated with the Web page. According to one embodiment, the filing information 814 associated with the e-mail message is also updated based on the metadata.

The URL address is stored in a directory structure in accordance with the metadata at 1210. For example, the user device 700 may store the URL address in the information address database 900 and update the filing information 912 as appropriate based on the metadata.

An indication associated with the e-mail message is stored along with the URL address at 1212. For example, the user device 700 may store the appropriate message identifier 910 in the information address database 900. In this way, an indication that the URL address was originally received via an e-mail message can be displayed to a user (e.g., via a message icon 422 in a list of URL addresses). Moreover, the user may activate the indication to view the e-mail message. After storing the indication associated with the e-mail message, the process ends at 1206.

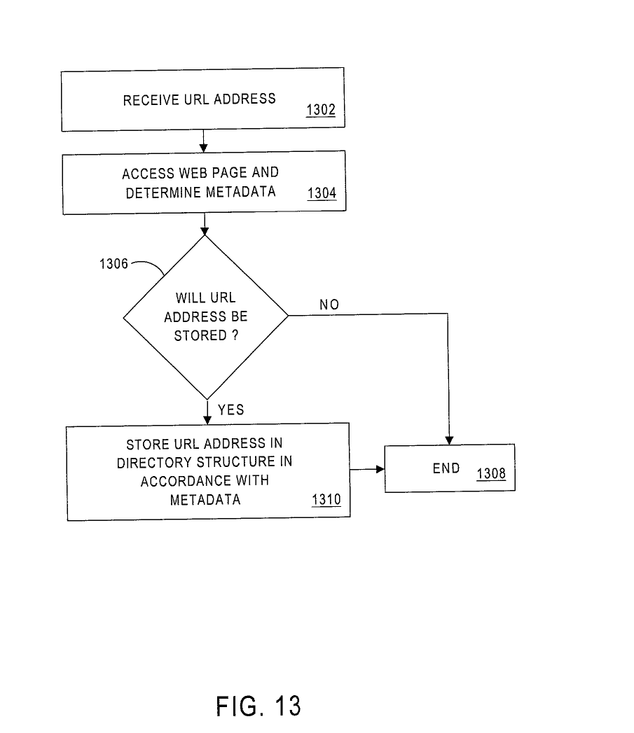

FIG. 13 is a flow chart of a computer-implemented method of facilitating storage of a URL address according to another embodiment of the present invention. The method may be performed, for example, by a user device 700. At 1302, a URL address is received at the user device 700 (e.g., when a user enters the URL address or selects a link on a Web page).

At 1304, a Web page associated with the received URL address is accessed and metadata is determined. For example, the user device 700 may receive HTML information and/or XML information from an information server 10. The user device 700 may then evaluate the information and/or receive information from a third-party device 40 to determine the metadata.

At 1306, it is determined whether or not the URL address will be stored based on the metadata. For example, the user device 700 may determine if the URL address will be stored based on the metadata, a user preference 1004 stored in the user preference database 1000, and/or a pre-determined rule 1104 stored in the pre-determined rule database 1100. If it is determined that the URL address will not be stored at 1306, the process ends at 1308.

If it is determined that the URL address will be stored at 1306, the URL address is stored in a directory structure in accordance with the metadata at 1310. For example, the URL address may be stored as an information address 906 in the information address database 900 along with the appropriate filing information 912 (e.g., indicating if the URL address should be stored in a “news” folder or a “sports” folder). After the URL address is stored, the process ends at 1308.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although some of the embodiments described herein are associated with a user device 700 determining whether or not an information address will be stored based on metadata, another embodiment is directed to the storage of a user identifier (associated with a user and/or a user device 700) at an information server 10. According to this embodiment, the information server 10 determines a user identifier (e.g., by accessing a cookie file stored at a user device 700). The information server 10 then determines metadata associated with the user (e.g., based on information received from the user device 700 and/or a third-party device 40). The information server 10 also determines whether or not the user identifier will be stored and/or how the user identifier will be stored based on the metadata.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating access with respect to an information address and an electronic message, wherein the information address is associated with information content and the electronic message is associated with a message address, comprising:
determining that the information address is related to the electronic message; and
associating the information address with at least one of: (i) the electronic message, and (ii) the message address.

2. The method of claim 1, wherein the information address comprises a uniform resource locator address, the information content comprises a Web page, the electronic message comprises an e-mail message, and the message address comprises an electronic mail address from which the e-mail message originated.

3. The method of claim 1, wherein said associating comprises:
providing an indication of the information address in association with an indication of the electronic message.

4. The method of claim 3, wherein the indication of the information address comprises an address icon displayed proximate to the indication of the electronic message in a list of electronic message indications.

5. The method of claim 4, wherein activation of the address icon results in display of at least one of: (i) the information address, and (ii) the information content.

6. The method of claim 3, wherein the indication of the electronic message comprises a message icon displayed proximate to the indication of the information address in a list of information address indications.

7. The method of claim 6, wherein activation of the message icon results in display of at least one of: (i) the message address, and (ii) the electronic message.

8. The method of claim 1, wherein said associating comprises:
storing an indication of the information address in association with an indication of the electronic message

9. The method of claim 8, wherein the stored indication of the information address comprises at least one of: (i) the information address, and (ii) the information content.

10. The method of claim 8, wherein the stored indication of the electronic message comprises at least one of: (i) the electronic message, and (ii) the message address.

11. The method of claim 8, further comprising:
determining metadata associated with at least one of: (i) the electronic message, and (ii) the information content,
wherein said storing is performed in accordance with the metadata.

12. The method of claim 11, wherein the metadata is associated with at least one of: (i) hypertext markup language information, (ii) extensible markup language information, (iii) bookmark exchange language information, (iv) keyword information, (v) category information, (vi) third-party information, (vii) rating information, (viii) quantity information, (ix) date information, (x) an information source, and (xi) a plurality of metadata types.

13. The method of claim 11, wherein information is stored in a directory structure in accordance with the metadata.

14. The method of claim 8, wherein a plurality of information addresses are associated with the indication of the electronic message.

15. The method of claim 1, wherein a plurality of electronic messages are associated with the indication of the information address.

16. The method of claim 1, wherein said associating is performed by at least one of: (i) a user device, (ii) a personal computer, (iii) a portable computing device, (iv) a personal digital assistant, and (v) a wireless telephone.

17. The method of claim 1, wherein the information address is associated with accessing the information content via at least one of: (i) the Internet, (ii) a Web site, (iii) a public network, (iv) a public switched telephone network, (v) a proprietary network, (vi) a cable network, (vii) a satellite network, (viii) a wireless network, and (ix) a Bluetooth network.

18. The method of claim 1, further comprising:
determining at least one of: (i) whether information will be stored, (ii) how long information will be stored, (iii) a device at which information will be stored, (iv) whether information will be deleted, (v) whether information will be replaced, and (vi) whether another electronic message will be generated.

19. An user device to facilitate access with respect to an information address and an electronic message, wherein the information address is associated with information content and the electronic message is associated with a message address, comprising:
a processor; and
a storage device in communication with said processor and storing instructions adapted to be executed by said processor to:
determine that the information address is related to the electronic message; and
associate the information address with at least one of: (i) the electronic message, and (ii) the message address.

20. The user device of claim 19, wherein said storage device further stores at least one of: (i) an electronic message database, (ii) an information address database, (iii) a user preference database, and (iv) a pre-determined rule database.

21. The user device of claim 19, further comprising:
a communication device coupled to said processor and adapted to communicate with at least one of: (i) an information server, (ii) another user device, (iii) a third-party device, and (iv) a payment device.

22. A medium storing instructions adapted to be executed by a processor to perform a method of facilitating access with respect to an information address and an electronic message, wherein the information address is associated with information content and the electronic message is associated with a message address, said method comprising:
determining that the information address is related to the electronic message; and
associating the information address with at least one of: (i) the electronic message, and (ii) the message address.

23. A computer-implemented method of facilitating access to a Web page, comprising:
receiving an e-mail message including a uniform resource locator address associated with the Web page;
determining metadata associated with at least one of: (i) the e-mail message, and (ii) the Web page;
storing the uniform resource locator address in a directory structure in accordance with the metadata; and
storing with the uniform resource locator address an indication associated with the e-mail message.

24. A method of facilitating storage of an information address associated with information content stored at an information server, comprising:
determining the information address;
determining metadata associated with the information content; and
determining at a user device remote from the information server whether the information address will be stored based on the metadata.

25. The method of claim 24, wherein the information address comprises at least one of: (i) a uniform resource locator address, (ii) an Internet protocol address, (iii) file transfer protocol information, (iv) Bluetooth information, and (v) a telephone number.

26. The method of claim 24, wherein said determining the information address comprises at least one of: (i) receiving the information address from a user, (ii) extracting the information address from an electronic message, (iii) extracting the information address from an instant message, (iv) extracting the information address from information content, and (v) retrieving a pre-stored indication of the information address.

27. The method of claim 24, wherein the metadata comprises at least one of: (i) hypertext markup language information, (ii) extensible markup language information, (iii) bookmark exchange language information, (iv) keyword information, (v) category information, (vi) third-party information, (vii) rating information, (viii) quantity information, (ix) date information, (x) an information source, and (xi) a plurality of metadata types.

28. The method of claim 24, wherein said determining the metadata comprises at least one of: (i) receiving the metadata from the information server, (ii) evaluating the information content, and (iii) receiving the metadata from a third-party.

29. The method of claim 24, wherein said determining whether the information address will be stored is further based on at least one of: (i) a pre-determined rule, and (ii) a user preference.

30. The method of claim 24, further comprising:
storing the information address at the user device.

31. The method of claim 30, wherein said storing is performed in accordance with the metadata.

32. The method of claim 31, wherein the information address is stored in a directory structure in accordance with the metadata.

33. The method of claim 30, further comprising:
storing the metadata at the user device.

34. The method of claim 24, further comprising:
determining, based on the metadata, at least one of: (i) how long the information address will be stored, (ii) a device at which the information address will be stored, (iii) whether the information address will be deleted from the user device, (iv) whether another information address will be deleted from the user device, (v) whether another information address will be replaced by the information address at the user device, and (vi) whether an e-mail message will be generated.

35. The method of claim 24, wherein the user device comprises at least one of: (i) a personal computer, (ii) a portable computing device, (iii) a personal digital assistant, (iv) a wireless telephone, and (v) a television device.

36. The method of claim 24, wherein the information address is associated with accessing the information content via at least one of: (i) the Internet, (ii) a Web site, (iii) a public network, (iv) a public switched telephone network, (v) a proprietary network, (vi) a cable network, (vii) a satellite network, (viii) a wireless network, and (ix) a Bluetooth network.

37. A user device, comprising:
a processor; and
a storage device in communication with said processor and storing instructions adapted to be executed by said processor to:
determine an information address;
determine metadata associated with the information content; and
determine whether the information address will be stored based on the metadata.

38. The user device of claim 37, wherein said storage device further stores at least one of: (i) an electronic message database, (ii) an information address database, (iii) a user preference database, and (iv) a pre-determined rule database.

39. The user device of claim 37, further comprising:
a communication device coupled to said processor and adapted to communicate with at least one of: (i) an information server, (ii) another user device, (iii) a third-party device, and (iv) a payment device.

40. A medium storing instructions adapted to be executed by a processor to perform a method of facilitating storage of an information address associated with information content stored at an information server, said method comprising:
determining the information address;
determining metadata associated with the information content; and
determining at a user device remote from the information server whether the information address will be stored based on the metadata.

41. A computer-implemented method of facilitating storage of a uniform resource locator address associated with a Web page, comprising:
receiving at a user device the uniform resource locator address;
determining at the user device metadata associated with the uniform resource locator address;
determining at the user device whether the uniform resource locator address will be stored based on the metadata; and
storing the uniform resource locator in a directory structure in accordance with the metadata.

42. A method of facilitating storage of a user identifier associated with a user device, comprising:
determining the user identifier;
determining metadata associated with the user device; and
determining at an information server remote from the user device at least one of: (i) whether the user identifier will be stored based on the metadata, and (ii) how the user identifier will be stored based on the metadata.
